(19) United States
(12) Patent Application Publication
(10) Pub. No.: US 2015/0277567 A1
(43) Pub. Date: Oct. 1, 2015

(54) SPACE STABILIZED VIEWPORT TO ENABLE SMALL DISPLAY SCREENS TO DISPLAY LARGE FORMAT CONTENT

(71) Applicant: Ryan P. Schiewe, Silverton, OR (US)

(72) Inventor: Ryan P. Schiewe, Silverton, OR (US)

(21) Appl. No.: 14/225,811

(22) Filed: Mar. 26, 2014

(51) Int. Cl. G06F 3/01; G06T 3/40

(52) U.S. Cl. CPC G06F 3/017; G06T 3/40

(57) ABSTRACT

In accordance with some embodiments a mobile small screen device may be enabled to view content as if the device itself were a looking glass or viewing port that enables the user to view the large screen format data by simply moving the device over the physical area that would have been covered by the large format data field at full size. Thus by merely moving the device around that field, the user can view any content on the field. Particularly in cases where the large format content is of a predetermined standard size, the user can quickly navigate to any area of the large format data to see a particular portion of that format and to make selections within particular areas of the large format.

### BACKGROUND

This relates generally to the display of information in connection with processor-based systems.

Some processor-based devices are small and therefore include relatively small screens. Examples of such devices includes cellular telephones, game devices, and tablets.

In some cases relatively large format documents may be displayed on these small screen devices. Large format documents or content may include files formatted for relatively large screen display. An issue then arises with respect to how to display the large format content, sized for display on a larger screen, on a smaller screen.

One solution to this problem is to provide a zoom function. For example in connection with some devices, including the Apple iphone®, the zoom function may be implemented on portable small screen devices like cellular telephones by spreading the thumb and forefinger outwardly. In other devices, a touch screen may be swiped to scroll the content in order to expose content hidden beyond the screen's viewable area.

While these techniques have many advantages, they make it relatively difficult to locate desired content in multiple dimensions. Generally there must be some combination of fingers spreading and screen swiping in order to try to navigate around the larger format displayable content. Since the user is operating to some degree without a good understanding of how big the large content data is, it is often difficult to find the data that the user wants. This may be important so that the user can view all data or so that the user can make selections in the large format content.

### BRIEF DESCRIPTION OF THE DRAWINGS

Some embodiments are described with respect to the following figures:

FIG. 1 is a depiction of embodiment in which the processor-based device is a physical device and is shown as if it was overlaid over the large format content F;

FIG. 2 is a depiction corresponding to FIG. 1 after the processor-based device has been moved in the direction of the arrow shown in FIG. 1 in accordance with one embodiment;

FIG. 3 is a corresponding depiction of the device after the device has been moved in the direction of the arrow and rotated as indicated by the rotary arrow in FIG. 2;

FIG. 4 is flow chart for one embodiment; and

FIG. 5 is a schematic depiction for one embodiment.

### DETAILED DESCRIPTION

In accordance with some embodiments, a mobile small screen device may enable larger screen format content to be viewed as if the device itself were a looking glass or space stabilized viewing port that enables the user to view the large screen format data by simply moving the device over the physical area that would have been covered by the large format content field at full size. Thus by merely moving the device around that virtual field, the user can view any content on the field. Particularly in cases where the large format content is of a predetermined standard size, the user can quickly navigate to any area of the large format content to see a particular portion of that content and to make selections within particular areas of the large format content.

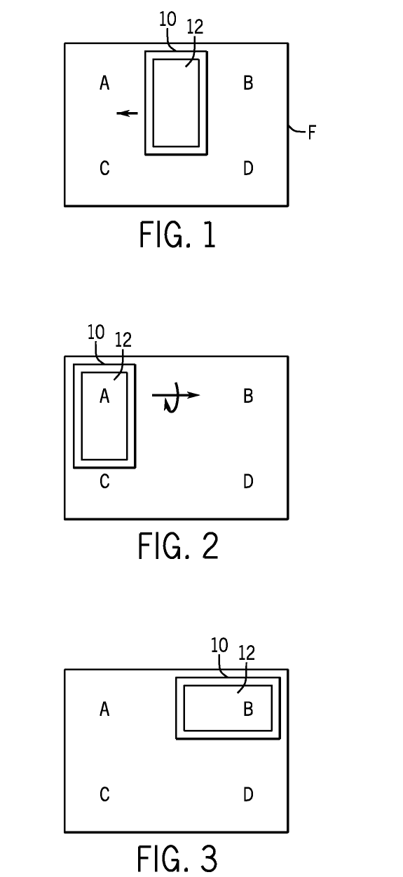

Thus referring to FIG. 1, the processor-based device 10 is illustrated with a screen 12 that is small relative to the size of the displayable content field F. The field F, in fact does not exist in a physical form but only exists as a file or virtual form whose content is intended to be displayed on a screen sized to correspond to the size of the field F. For example the field F may be of a size conventionally shown on a tablet or laptop computer display. But in this case, it is displayed on the small screen 12.

In FIG. 1, four object images corresponding to the letters A, B, C, and D are depicted in different quadrants of the field F in this example. When the small screen processor-based device 10 is moved in the direction of the arrows shown in FIG. 1 to the position shown in FIG. 2, the corresponding portion of the field F is displayed, in this case displaying the letter A.

Likewise when the small screen format device 12 is moved in the direction of the arrow in FIG. 2 and rotated 90° to the position shown in FIG. 3, the character B is displayed in a landscape screen orientation.

In sum, the user can simply move the processor-based device 10 in any direction and distance and those directions and distances may then be correlated to positions within the larger area of the field F and the corresponding portion of the field F is then displayed on the screen 12 as if one were simply moving a looking glass over a large object such as a map. Again, in the physical world, the field F does not exist.

In one embodiment, the movements in two dimensions in a plane parallel to the ground may be recognized. The direction and extent of movement may be correlated to a position on the larger format field. As a result, the information corresponding to that position is displayed. The movement can be in any direction substantially within the plane and the movement may include rotation within the plane.

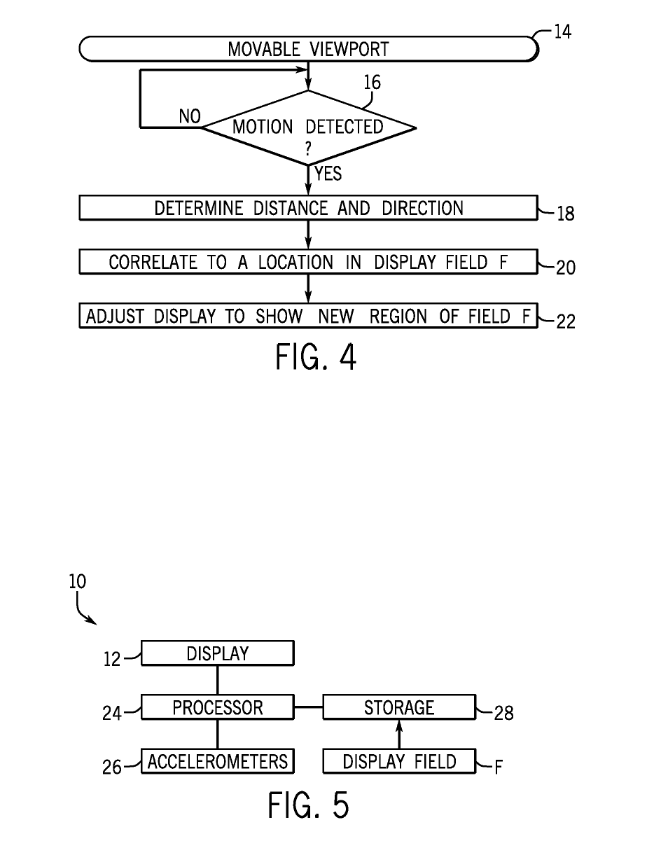

According to some embodiments, a moveable viewport sequence 14 shown in FIG. 4 may be implemented in software, firmware and/or hardware. In software and firmware embodiments it may be implemented by computer executed instructions stored in one or more non-transitory computer readable media such as magnetic, optical or semiconductor storages. For example, the sequence may be stored as an application or as an executable file in any memory including system memory.

The sequence shown in FIG. 4 begins as indicated at diamond 16 by detecting motion as a whole of the processor-based device itself including its processor. In some embodiments only motion of a particular type such as motion of a particular distance, or motion of a particular speed is detected to prevent inadvertent activation of this feature. In other embodiments the viewport feature may only be activated when large format content is currently being displayed. In one embodiment, a user selection, for example of an icon, is required to activate the feature.

If device motion is detected at diamond 16, the distance and direction of the motion is determined as indicated in block 18. This includes a determination of any rotation of the device itself. In one embodiment accelerometers are used for this purpose. Then the direction and extent of motion is correlated to a location in the large format display field F, as indicated in block 20. Finally the display of the screen 12 is adjusted to show a region of the field F that corresponds to the extent and direction of motion that has been detected as indicated in block 22.

In accordance with some embodiments, the processor-based device 10 may be a cellular telephone or any other mobile device with a small screen display including a portable game device, an e-book reader or a tablet computer, to mention a few examples.

As shown in FIG. 5, the processor-based device 10 may have a display 12 coupled to a processor 24. The processor 24 in turn may be coupled to a storage 28 which may store a file that corresponds to the display field F as indicated. A plurality of accelerometers 26 may be distributed around the housing for the processor-based device 10 in order to detect motion in multiple directions. For example in one embodiment when the device has moved in two dimensions within a horizontal plane, the virtual viewport is moved over the field F.

When the device is moved away from that horizontal plane, either upwardly or downwardly, the device may act as if it were a magnifying glass to either increase the size of what is displayed or to decrease its size and to show a greater or lesser area of the field F. Similarly in some embodiments conventional techniques for showing large format content data may be used in addition to the techniques described herein including swiping or scrolling and pinching and spreading of the forefinger and thumb in order to enlarge or contract particular areas.

While in one embodiment the device can be moved in a two dimensional plane to view content, in a simpler embodiment, only one dimension of movement may be allowed.

In another embodiment, motion can be sensed by rollers as the device is moved on a surface. The rollers may work like rollers sometimes used on mouse input devices.

In another embodiment, an optical sensor may be used to detect motion. The optical sensor may work like the optical sensors used with an optical mouse.

In one embodiment, a small inset display may be selected to show the position of the device over the field F and to give the user an idea about how to access the rest of the information within the field F.

In accordance with still another embodiment, instead of moving the actual processor-based device in total, one may simply enter a mode in which movements of a mouse connected to that device cause the viewport to move over a virtual, larger display field. Thus, cursor movements may be recognized as a request to move the virtual viewport over the field F. This mode may be implemented by selecting an icon, for example or by pressing an appropriate mouse button.

In yet another embodiment, instead of recognizing movements of the display, movements of the user's hands may be recognized as commands to move the viewport over the field F in at least two dimensions. These hand motions may be detected by a camera and may be identified using video analytics as gestural commands causing the viewport to move to display a different portion of the available field in correspondence with the extent and direction of movement of the user's hands.

The following clauses and/or examples pertain to further embodiments:

One example embodiment may be a method comprising detecting motion while displaying a portion of a file viewable on a display, and changing a display of said file based on the direction and extent of motion such that the display of information is changed as if the display is a viewport to reveal a portion of file exposed through said viewport as a result of repositioning of the viewport. The method may also include detecting device movement to view a larger format content on a smaller format display. The method may also include detecting motion in at least two directions. The method may also include detecting motion in two dimensions. The method may also include detecting motion in two dimensions within a horizontal plane parallel to ground. The method may also include enabling the device to display information as if it were a viewport with a smaller field of view, the viewport being moveable over a virtual field that is larger than the viewport to enable a user to view the field by moving the viewport. The method may also include enabling the device to display information as if it were a viewport with a smaller field of view, the viewport being moveable over a virtual field that is larger than the viewport to enable a user to view the field by moving the viewport. The method may also include detecting motion of only a portion of a processor based device. The method may also include detecting user motion.

In another example embodiment may be one or more non-transitory computer readable media storing instructions for execution by a processor based device to perform a sequence comprising detecting motion of the processor based device while displaying a first region of a file, and changing a display of said device based on the direction and extent of motion to display a second region of said file. The media may also include detecting device movement to view a larger format content on a smaller format display. The media may also include detecting motion in at least two directions. The media may also include detecting motion in two dimensions. The media may also include detecting motion in two dimensions within a horizontal plane parallel to ground.

Another example embodiment may be a processor based device comprising a processor to detect motion of the processor based device while displaying a first region of a file and change a display of said device based on the direction and extent of motion to display a second region of said file, and a storage coupled to said processor. The device may include said processor to detect device movement to view a larger format content on a smaller format display. The device may include said processor to detect motion in at least two directions. The device may include said processor to detect motion in two dimensions. The device may include said processor to detect motion in two dimensions within a horizontal plane parallel to ground. The device may include said processor to enable the device to display information as if it were a viewport with a smaller field of view, the viewport being moveable over a virtual field that is larger than the viewport to enable a user to view the field by moving the viewport.

In another example embodiment may be an apparatus comprising a processor, a display coupled to said processor, and a motion sensor coupled to said processor to detect motion of said apparatus including motion of said processor, said processor to change a region of a file that is displayed based on motion of said apparatus sensed by said motion sensor. The apparatus may be coupled to said processor, said processor to detect device movement to view a larger format content on a smaller format display. The apparatus may include said processor to detect motion in at least two directions. The apparatus may include said processor to detect motion in two dimensions. The apparatus may include said processor to detect motion in two dimensions within a horizontal plane parallel to ground. The apparatus may include said processor to enable the device to display information as if it were a viewport with a smaller field of view, the viewport being moveable over a virtual field that is larger than the viewport to enable a user to view the field by moving the viewport.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. A method comprising:
detecting motion while displaying a portion of a file viewable on a display; and
changing a display of said file based on the direction and extent of motion such that the display of information is changed as if the display is a viewport to reveal a portion of file exposed through said viewport as a result of repositioning of the viewport.

2. The method of claim 1 including detecting device movement to view a larger format content on a smaller format display.

3. The method of claim 1 including detecting motion in at least two directions.

4. The method of claim 3 including detecting motion in two dimensions.

5. The method of claim 4 including detecting motion in two dimensions within a horizontal plane parallel to ground.

6. The method of claim 1 including enabling the device to display information as if it were a viewport with a smaller field of view, the viewport being moveable over a virtual field that is larger than the viewport to enable a user to view the field by moving the viewport.

7. The method of claim 1 including detecting motion of an entire processor based device.

8. The method of claim 1 including detecting motion of only a portion of a processor based device.

9. The method of claim 1 including detecting user motion.

10. One or more non-transitory computer readable media storing instructions for execution by a processor based device to perform a sequence comprising:
detecting motion of the processor based device while displaying a first region of a file; and
changing a display of said device based on the direction and extent of motion to display a second region of said file.

11. The media of claim 10 including detecting device movement to view a larger format content on a smaller format display.

12. The media of claim 10 including detecting motion in at least two directions.

13. The media of claim 12 including detecting motion in two dimensions.

14. The media of claim 13 including detecting motion in two dimensions within a horizontal plane parallel to ground.

15. A processor based device comprising:
a processor to detect motion of the processor based device while displaying a first region of a file and change a display of said device based on the direction and extent of motion to display a second region of said file; and
a storage coupled to said processor.

16. The device of claim 15, said processor to detect device movement to view a larger format content on a smaller format display.

17. The device of claim 15, said processor to detect motion in at least two directions.

18. The device of claim 17, said processor to detect motion in two dimensions.

19. The device of claim 18, said processor to detect motion in two dimensions within a horizontal plane parallel to ground.

20. The device of claim 15, said processor to enable the device to display information as if it were a viewport with a smaller field of view, the viewport being moveable over a virtual field that is larger than the viewport to enable a user to view the field by moving the viewport.

21. An apparatus comprising:
a processor;
a display coupled to said processor; and
a motion sensor coupled to said processor to detect motion of said apparatus including motion of said processor, said processor to change a region of a file that is displayed based on motion of said apparatus sensed by said motion sensor.

22. An apparatus of claim 21 coupled to said processor, said processor to detect device movement to view a larger format content on a smaller format display.

23. The apparatus of claim 21, said processor to detect motion in at least two directions.

24. The apparatus of claim 23, said processor to detect motion in two dimensions.

25. The apparatus of claim 24, said processor to detect motion in two dimensions within a horizontal plane parallel to ground.

26. The apparatus of claim 21, said processor to enable the device to display information as if it were a viewport with a smaller field of view, the viewport being moveable over a virtual field that is larger than the viewport to enable a user to view the field by moving the viewport.
